(19) United States
(12) Patent Application Publication
(10) Pub. No.: US 2007/0286216 A1
(43) Pub. Date: Dec. 13, 2007

(54) Internet access method and apparatus for an internet phone

(75) Inventors: Yao Hsing Chung, Taipei (TW); Yu Wei Jhang, Taipei (TW)

Correspondence Address: BACON & THOMAS, PLLC, 625 SLATERS LANE, FOURTH FLOOR, ALEXANDRIA, VA, 22314, US

(73) Assignee: Color City Enterprise Co., Ltd., Apia (WS)

(21) Appl. No.: 11/503,230

(22) Filed: Aug. 14, 2006

(30) Foreign Application Priority Data
Jun. 9, 2006 (TW) 095120715

(51) Int. Cl. H04L 12/56

(52) U.S. Cl. 370/401

(57) ABSTRACT

An Internet access apparatus for an Internet phone is provided, it comprises an Internet phone host disposed between a personal home computer and an ADSL modem. The personal home computer is connected to the Internet phone host, the Internet phone host is connected to the ADSL modem, the ADSL modem is connected to the Internet, and a phone is connected to the Internet phone host. The Internet phone host automatically picks up and saves the PPPOE account number, password and other relative parameters sent out by the personal computer when connecting to the Internet, so as to enable the phone to connect to the Internet via the Internet phone host.

### FIELD OF THE INVENTION

The present invention relates to an Internet access method and apparatus for an Internet phone, and more particularly to an Internet access method and apparatus for a home-use Internet phone.

### BACKGROUND OF THE INVENTION

It is comparatively cheap to make a phone call through the Internet, and that's why the Internet phone is popularized. Internet phone generally includes company Internet phone and home-use Internet phone. The company Internet phone is managed by the designated persons, so there is no problem in internet accessing. But for the home-use internet phone, internet accessing is not easy.

FIG. 1 is an illustrative view of a home-use Internet phone, wherein a personal home computer 1 is connected to an ADSL modem 2 that is connected with the Internet 3, and a internet phone host 4 is also connected to the ADSL modem 2 directly. The personal home computer 1 is connected to the Internet 3 through PPPOE (Point to Point Protocol Over Ethernet), and the Internet 3 is only accessible by providing a correct account number and password that have already been set in the personal home computer 1. Therefore, connecting the personal home computer 1 to the Internet 3 is very convenient. However, it must also provide PPPOE account number and password when connecting the internet phone host 4 to the Internet 3, this is very inconvenient for most of the personal home computer users, since they not only have to remember the account number and password by heart, but also need to enter English letters by pressing the number keys of a phone 41.

The present invention has arisen to mitigate and/or obviate the afore-described disadvantages of the conventional Internet phone.

### SUMMARY OF THE INVENTION

The primary objective of the present invention is to provide an Internet access apparatus for an Internet phone comprising an Internet phone host disposed between a personal home computer and an ADSL modem, and a phone is connected to the Internet phone host. The personal home computer is connected to the Internet phone host, the Internet phone host is connected to the ADSL modem, and the ADSL modem is connected to the Internet. The Internet phone host automatically picks up and saves the PPPOE account number, password and other relative parameters sent out by the personal home computer when connecting to the Internet, so as to enable the phone to be connected to the Internet via the Internet phone host.

If the user wants to use the phone to call through the Internet, he turns on the personal home computer and the Internet phone host, and then the Internet phone host by itself will carry out the following steps:

1) Activating DHCP mode, if IP is obtained successfully, the connected computer system and phone system must be in company mode, therefore the Internet phone host connects the company phone system to the Internet with the DHCP mode;

2) If it is failure to activate the DHCP mode, the connected computer and the phone system must be in personal home mode of PPPOE, then connecting to the Internet by activating Bridge/Hub mode;

3) Activating the personal home computer and connecting it to the Internet;

4) The Internet phone host automatically picks up and saves the PPPOE account number, password and other relative parameters sent out by the personal home computer when connecting to the Internet;

5) The Internet phone host by itself converts into Router mode and cuts off the personal home computer from the Internet;

6) The Internet phone host connects to the Internet via PPPOE mode and sends IPs to the phone and the personal home computer, so that the phone and the personal home computer can be connected to the Internet via the Internet phone host.

### BRIEF DESCRIPTION OF THE DRAWINGS

FIG. 1 is an illustrative view of a conventional personal home Internet phone;

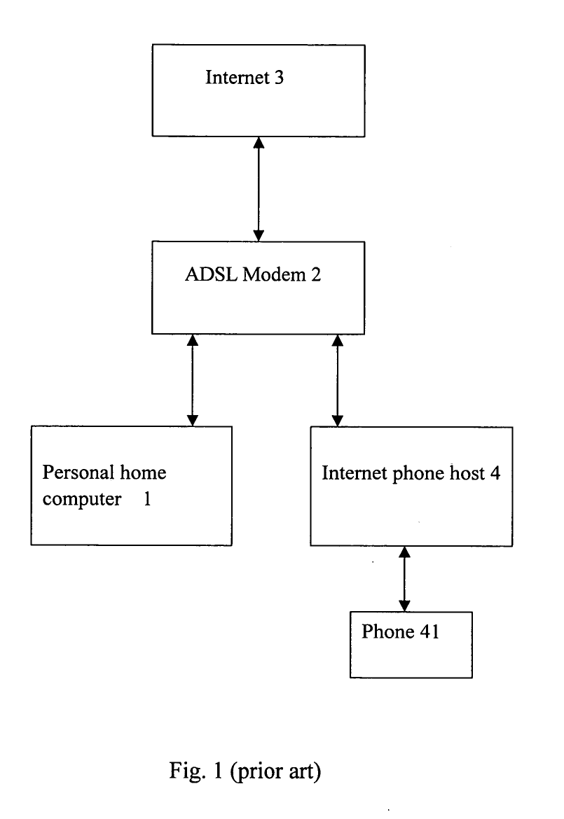

FIG. 2 is an illustrative view of an Internet access apparatus for an Internet phone in accordance with the present invention; and

FIG. 3 is a flow chart of showing an Internet access method for an Internet phone in accordance with the present invention.

### DETAILED DESCRIPTION OF THE PREFERRED EMBODIMENTS

The present invention will become clearer from the following description when viewed together with the accompanying drawings, which show, for purpose of illustrations only, the preferred embodiment in accordance with the present invention.

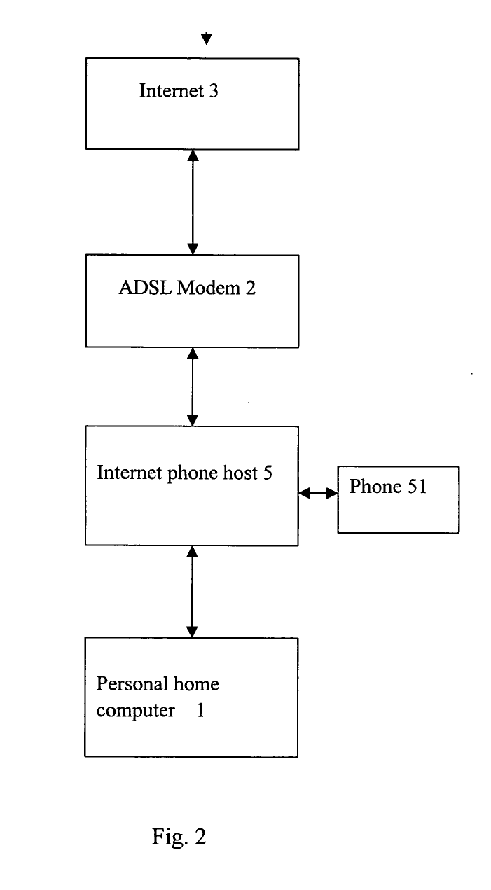

Referring to FIG. 2, which is an illustrative view of an Internet access apparatus for an Internet phone in accordance with the present invention. As shown, an Internet phone host 5 is disposed between a personal home computer 1 and an ADSL modem 2. The personal home computer 1 is connected to the Internet phone host 5, the Internet phone host 5 is connected to the ADSL modem 2, the ADSL modem 2 is connected to the Internet 3, and then a phone 51 is connected to the Internet phone host 5.

The way that Internet phone host 5 and the ADSL modem 2 are connected is WAN (wide area network), and the way that the Internet phone host 5 and the personal home computer 1 are connected is LAN (local area network). The LAN terminal of the Internet phone host 5 provides two Internet access modes: DHCP (Dynamic Host Control Protocol) and Bridge/Hub.

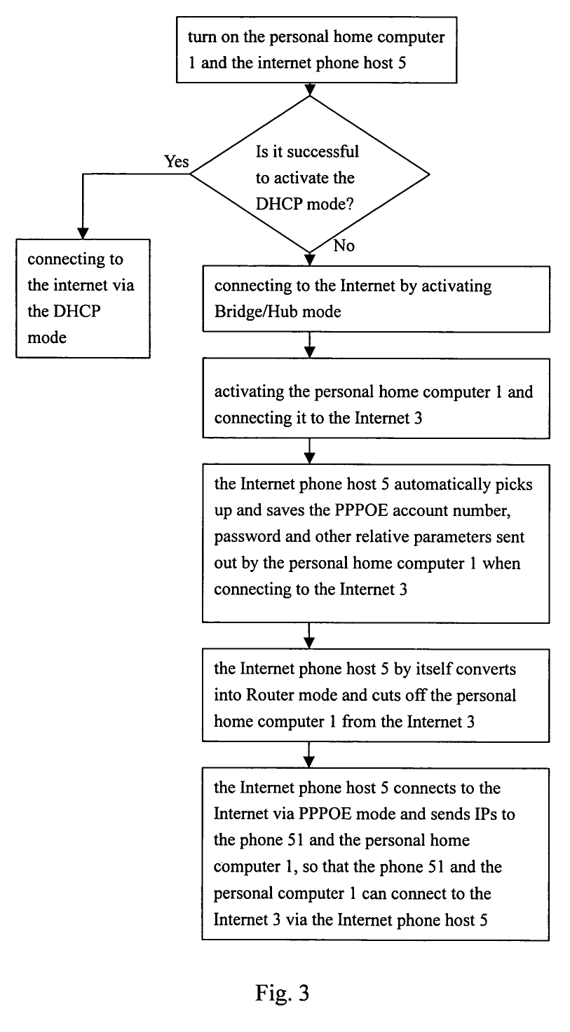

If the user wants to connect the Internet phone host 5 to the Internet 3, he first turns on the personal home computer 1 and the Internet phone host 5, and then the Internet phone host 5 by itself will carry out the following steps (with reference to FIG. 3):

1. Activating the DHCP mode, if the IP is obtained successfully, the connected computer system and the phone system must be in company mode, therefore, the Internet phone host 5 connects the company phone system to the Internet 3 with the DHCP mode;

2. If it is failure to activate the DHCP mode, the connected computer and the phone system must be in personal home mode, then connecting to the Internet 3 by activating Bridge/Hub mode;

3. Activating the personal home computer 1 and connecting it to the Internet 3;

4. The Internet phone host 5 automatically picks up and saves the PPPOE account number, password and other relative parameters sent out by the personal home computer 1 when connecting to the Internet 3;

5. The Internet phone host 5 by itself converts into Router mode and cuts off the personal home computer 1 from the Internet 3;

6. The Internet phone host 5 connects to the Internet 3 via PPPOE and sends IPs to the phone 51 and the personal home computer 1, so that the phone 51 and the personal home computer 1 can be connected to the Internet via the Internet phone host 5.

Since the Internet phone host 5 has automatically picked up and saved the PPPOE account number and password sent out by the personal home computer 1 when connecting to the Internet, the user doesn't need to memorize the PPPOE account number and password when connecting the phone 51 to the Internet, it is convenient.

While we have shown and described various embodiments in accordance with the present invention, it is clear to those skilled in the art that further embodiments may be made without departing from the scope of the present invention.

What is claimed is:

1. An Internet access apparatus for an Internet phone, comprising an Internet phone host disposed between a personal home computer and an ADSL modem, and a phone is connected to the Internet phone host, wherein the personal computer is connected to the Internet phone host, the Internet phone host is connected to the ADSL modem, and the ADSL modem is connected to an Internet.

2. An Internet access method for an Internet phone, including the Internet access apparatus as claimed in claim 1, if a user wants to use the phone to connect to the Internet, the user first turns on the personal home computer and the Internet phone host, and then the Internet phone host by itself will carry out the following steps:
1) activating DHCP mode, if an IP is obtained successfully, the connected computer system and phone system must be in a company mode, therefore, the Internet phone host connects the connected computer system and phone system to the Internet with the DHCP mode;
2) if failure to activate the DHCP mode, the connected computer and the phone system must be in personal home mode, then connecting to the Internet by activating Bridge/Hub mode;
3) activating the personal home computer and connecting it to the Internet;
4) the Internet phone host automatically picks up and saves the PPPOE account number, password and other relative parameters sent out by the personal home computer when connecting to the Internet;
5) the Internet phone host by itself converts into Router mode and cuts off the personal home computer from the Internet;
6) the Internet phone host connects to the Internet via PPPOE and sends IPs to the phone and the personal home computer, so that the phone and the personal home computer can connect to the Internet via the Internet phone host.
